(19) United States
(12) Patent Application Publication
(10) Pub. No.: US 2026/0044819 A1
(43) Pub. Date: Feb. 12, 2026

(54) Physical Property Inventory Control System and Method

(71) Applicants: Russell Zarse, Chattahoochee Hills, GA (US); John Osmanski, Chattahoochee Hills, GA (US)

(72) Inventors: Russell Zarse, Chattahoochee Hills, GA (US); John Osmanski, Chattahoochee Hills, GA (US)

(21) Appl. No.: 19/294,083

(22) Filed: Aug. 7, 2025

Related U.S. Application Data
(60) Provisional application No. 63/680,480, filed on Aug. 7, 2024.

(51) Int. Cl. G06Q 10/087; G06T 7/70

(52) U.S. Cl. CPC G06Q 10/08724; G06Q 10/0877; G06T 7/70; G06T 2207/30204

(57) ABSTRACT

Systems and methods generate and use an inventory map from a photograph of at least one physical object within a physical space. A server receives a photograph captured by a client device, parses the photograph to decode identification markers associated with an object, a container that holds the object, or a location indicator, and creates or updates an inventory record with a hierarchical location subrecord (e.g., address, building, room or space, shelf or collection space, container). When accompanying sensor data (orientation, positioning, inertial, depth) is available, the system determines and stores three-dimensional position attributes for the object within the container or space. A space component produces a two-dimensional plan and/or a three-dimensional view that places graphical representations according to the stored associations and positions. In some implementations, the system requests assignment of physical storage space from a storage provider and updates the inventory record with allocation results.

### BACKGROUND OF THE INVENTION

Throughout their lifetime humans obtain, use, transfer, and store personal property. Increasingly, people are acquiring vastly more personal property throughout their lifetime then they know what to do with. Identifying, organizing, storing, and disposing of said property is difficult for an individual due to at least space, energy, and time constraints; resulting in millions of square feet of personal property sitting in garages, basements, and storage facilities stagnant without its value being realized by society and eventually likely ending up in a landfill to decay, unused. A solution is needed which allows an individual to quickly and easily inventory, organize, store, and manage their personal property is needed to help humankind make more effective use of existing physical property.

### BRIEF DESCRIPTION

An object of the invention is to provide a system to track, find, and manage physical property located at one or more locations.

Another object of the invention is to attach information attributes to a digital record associated with physical property in order to provide information about the physical property to a user of the property and/or future owners.

Another object of the invention is to allow a user to organize and facilitate physically sending and receiving physical property to/from one or more physical property storage locations from a location remote from the one or more physical property storage locations.

Another object of the invention is to provide a digital representation of physical property for use on/through third party platforms, systems, and websites.

Another object of the invention is to obtain and provide physical property usage information to users regarding their procurement, usage, storage, and disposal of physical property.

Another object of the invention is to provide a more efficient pathway to recycling and physical property reuse opportunities for personal property.

Another object of the invention is to provide a chain of custody for physical objects.

Another object of the invention is, based on an image of a physical object, create a location and nested container structure from the image.

### BRIEF DESCRIPTION OF DRAWINGS

FIG. 1 illustrates a system configured for facilitating transactions of physical items between one or more users of an online platform in accordance with one or more implementations.

FIG. 2 is a flowchart of a traditional process of building an inventory map.

FIG. 3. is a flowchart illustrating a first step of a new approach to creating an inventory map.

FIG. 4. is a flowchart illustrating a second step of a new approach to creating an inventory map using an embodiment of the invention.

FIG. 5 is an illustrative view of one embodiment of an arrangement of containers utilized in the new approach to creating an inventory map.

FIG. 6 is transactional diagrams illustrating a process of creating, shipping, sale/displaying, and disposal of an inventory component.

### DETAILED DESCRIPTION OF THE INVENTION

For the following defined terms, these definitions shall be applied, unless a different definition is given in the claims or elsewhere in this specification. All numeric values are herein assumed to be modified by the term “about,” whether or not explicitly indicated. The term “about,” in the context of numeric values, generally refers to a range of numbers that one of skill in the art would consider equivalent to the recited value (e.g., having the same function or result). In many instances, the term “about” may include numbers that are rounded to the nearest significant figure. Other uses of the term “about” (e.g., in a context other than numeric values) may be assumed to have their ordinary and customary definition(s), as understood from and consistent with the context of the specification, unless otherwise specified. Although some suitable dimensions, ranges, and/or values pertaining to various components, features and/or specifications are disclosed, one of skill in the art, incited by the present disclosure, would understand desired dimensions, ranges, and/or values may deviate from those expressly disclosed.

As used in this specification and the appended claims, if any, the singular forms “a”, “an”, and “the” include plural referents unless the content clearly dictates otherwise. As used in this specification and the appended claims, the term “or” is generally employed in its sense including “and/or” unless the content clearly dictates otherwise. It is to be noted that in order to facilitate understanding, certain features of the disclosure may be described in the singular, even though those features may be plural or recurring within the disclosed embodiment(s). Each instance of the features may include and/or be encompassed by the singular disclosure(s), unless expressly stated to the contrary.

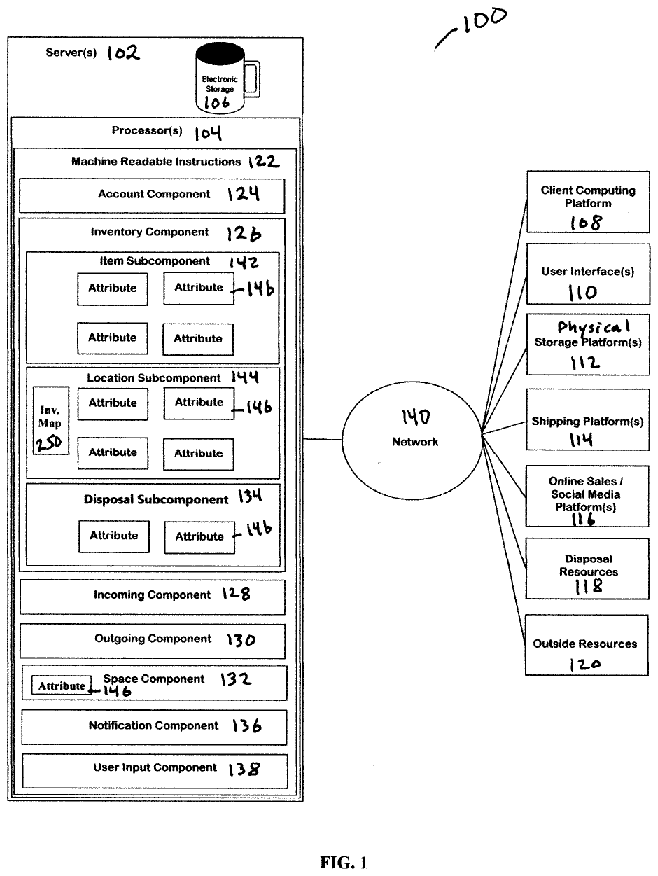

FIG. 1 illustrates a system 100 configured for facilitating the organization and management of, and if desired, transactions of, physical items between one or more users in accordance with one or more embodiments/implementations. By way of example, in some embodiments system 100 may comprise one or more servers 102, one or more processors 104, electronic storage 106, one or more client computing platforms 108, one or more user interfaces 110, one or more physical storage platforms 112, one or more shipping platforms 114, one or more social media/sales platforms 116, and/or one or more disposal resources 118, and/or other components. In an alternative embodiment, one or more online sales and/or social media platforms 116 is also included.

Server(s) 102 may be configured to communicate with one or more client computing platforms 108 according to a client/server design and/or other designs/architectures (such as via website or software application stored on, or providing access to, server(s) 102). Client computer platform(s) 108 may be configured to communicate with other client computer platforms via server(s) 102 and/or via a peer-to-peer architecture and/or other communication architectures/designs. Users may interface with system 100 via client computer platform(s) 108.

The users may include one or more personal property users, one or more shipping users, one or more storage users, one or more sales users, one or more social media users, one or more disposal users, and/or other users. For example, the users may include a first user, second user, third user, fourth user, and so on. Further, it is contemplated an individual user of one type may also be a user of a different time, such as a personal property user may also be a social media user.

Server(s) 102 may be configured by machine-readable instructions 122. Machine-readable instructions 122 may include one or more instruction components. The instruction components may include computer program components. The instruction components may comprise one or more of the following: account component 124, inventory component 126, incoming component 128, outgoing component 130, space component 132, notification component 136, user input component 138, and/or other instruction components. Inventory component 126 comprises an item subcomponent 142, a location subcomponent 144, a disposal subcomponent 134 and/or other subcomponents. Item subcomponent 142 comprises one or more attributes 146, location subcomponent 144 also comprises one or more attributes 146, and disposal subcomponent 134 additionally comprises one or more attributes 146. For ease of reference, the term “subcomponent” and “subrecord” are interchangeable. For example, the attributes may include a first attribute, second attribute, third attribute, fourth attribute, and so on.

Account component 124 may be configured to manage user accounts for users with access to server(s) 102 (and thus inventory component(s) 126), including but not limit to the users of a software application or website running on, or accessible by, a client computing platform 108 via user interface 110. In some embodiments, account component 124 may be configured to manage user accounts in one or more physical storage platforms 112, shipping platforms 114, and/or online sales and/or social media platforms 116 and if desired, enable a linkage/communication between user account(s) of users of server(s) 102 and user accounts in one or more physical storage platforms 112, shipping platforms 114, and/or online sales and/or social media platforms 116.

Inventory component 126 may be configured to digitally represent or include information about one or more physical objects. In some embodiments, this information includes one or more item subcomponent 142 which comprises one or more attributes 146 relevant to the one or more physical objects. The term relevant may include, without limiting the definition, information related to the intended or actual usage, a characteristic or quality of, condition, value, time period of use, and/or provenance. For example, a first attribute 146 may include a digital image of the physical object(s); a second attribute 146 may include a name or label for the object(s) (such as by text or other identification mechanisms such as an UPC, ISBN, geotag, RFID, etc.); a third attribute 146 may include a usage indication (such as seasonal or desired or actual specific time period use, such as month); a fourth 146 attribute may include information regarding the physical object(s) provenance, such as a digital image of a receipt for purchase of the object(s); a fifth attribute 146 may indicate if the user wishes to share the inventory component 126 (and accompanying attribute 146 information) with other users of system 100 or share inventory component 126 with other platforms like an online sales and/or social media platform 116 for example; a sixth attribute 146 indicating physical object(s) are to be disposed of via disposal resources 118; a seventh attribute 146 indicating the date in which the object(s) was/were last used; a eighth attribute 146 indicating the subjective level of importance (such as on a scale of 1 to 10 or another rating format) the physical object(s) represent to a user; a ninth attribute 146 indicating the quantity of object(s) in the inventory subcomponent 142; a tenth attribute 146 may indicate whether to item is physically in the possession of a physical storage platform 112; an eleventh attribute 146 indicating the date/time and/or frequency of check in/check out from a physical storage platform 112; a twelfth attribute 146 may be an image of a container(s) the physical object(s) is located within; a thirteenth attribute 146 may short or long term safety or health concerns associated with the object, and other attributes.

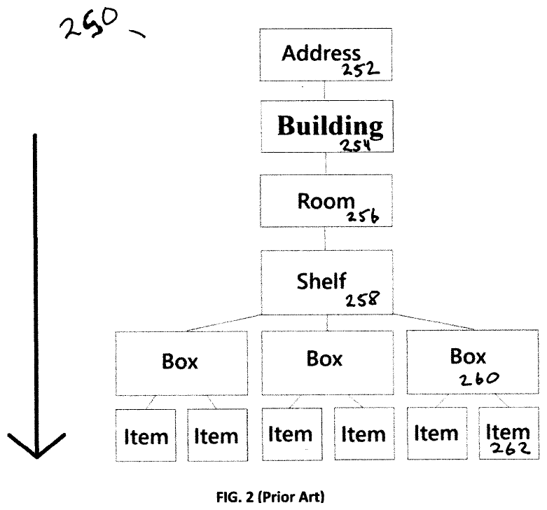

In some embodiments, this information also/or includes a location subcomponent 144 which comprises one or more attributes 146 related to the geographic location in space (X, Y, and/or Z axis) of one or more physical objects (which may be centrally located or another spatial location). For example, a first attribute 146 may indicate if the object(s) is/are located within a first box 260 (see FIG. 2); a second attribute 146 may indicate a height, width, and length of the object(s); a third attribute 146 may indicate a weight of the object(s); a fourth attribute 146 may indicate location in space (X, Y, and Z axis) of the object(s) within the first container; a fifth attribute 146 may indicate location in space (X, Y, and Z axis) of a point within the volume of the first container the objects(s) are located within (or the entire volume itself, estimated or actual); a sixth attribute 146 may indicate if the object(s) is/are located within a second container (and so forth to the n^{th} container, which accommodates for nesting of a physical object within multiple containers); a seventh attribute 146 may indicate a length of time the objects(s) have been located at a geographic location and other location based attributes; an eighth attribute 146 may indicate a physical location of the physical object, such as longitude and latitude or physical mailing or building address; a ninth attribute 146 may indicate a room or space the physical object is located; a tenth attribute 146 may indicate a shelf or collection the physical object (or container(s) the physical object is within) is located and other location based attributes. Further, location subcomponent contains an inventory map 250, which contains nesting and location information of an item subcomponent within containers as well as location within one or more containers. In some embodiments, a single photograph/image that depicts at least one physical object within a container is sufficient; the server(s) 102 parses the image to decode identification markers and to populate the hierarchical location subcomponent for the object. When a user includes sensor payloads (e.g., GPS, orientation, inertial, or depth data), the system 100 determines and persists (X, Y, Z) position attributes for the object within the space or container.

In some embodiments, this information also/or includes a disposal subcomponent 134 which comprises one or more attributes 146 which may organize multiple inventory component(s) 126 by one or more shared disposal attribute(s) 146 and which may be provided to disposal resources 118 to facilitate disposal of the physical object(s) an inventory component 126 represents. For example, a first attribute 146 may indicate a material composition of the physical object(s), such as plastic, metal, cardboard, paper, etc.; a second attribute 146 may indicate the component(s) contains one or more lithium ion batteries or other desirable material composition; a third attribute may indicate a specific method of disposal for the associated component such as composting, recycling or landfill disposal; a fourth attribute may indicate if the component needs further processing before disposal; a fifth attribute may indicate a shelf usable life, or expiration date of an object; a sixth attribute may indicate legal, safety, health, or environmental requirements/concerns associated with disposal of the object; a seventh attribute may indicate if the object has specific disposal restrictions imposed by state or federal law or local ordinance, and other disposal based attributes.

Incoming component 128 may be configured to receive requests or information from users and platforms as well as information from users and platforms pertaining to an account component 124 and/or inventory component 126, including but not limited to, requests from client computer platform(s) 108; requests from a user to create or alter an inventory component 126; requests from a user to create or alter one or more item subcomponent 142 attribute(s) 146 associated with one or more inventory component(s) 126; requests from a user to create or alter one or more location subcomponents 144 attributes(s) 146 associated with one or more inventory component(s) 126; requests from a user to create or alter one or more disposal subcomponent 134 attribute(s) 146 associated with one or more inventory component(s) 126; to share existing and/or new inventory component information 126 with a physical storage platform 112, shipping service platform 114, disposal resource 118, online sales and/or social media platform 116 or other users on any of these platforms; to delete an inventory component 126; to assign legal ownership of a physical object(s) associated with an inventory component 126 and other requests.

Outgoing component 130 may be configured to send requests or information to users and platforms, including but not limited to, client computing platform 108, physical storage platform(s) 112, shipping platform(s) 114, online sales and/or social media platforms 116, disposal resources 118, and/or outside resources 120 such as an email server/service and/or print server/printer.

Space component 132 may be configured to store information related to one or more available physical space(s)/containers via an attribute 146 such as an address, building, room, or shelf where an inventory component(s) 126 (and any associated containers or shared space such as a shelf or column) are stored/physically located. This information can include volume information, weight restrictions, access limitations, hours of operation, etc. Such information may be supplied by a user and/or storage platform(s) 112. Space component 132 further may be configured to calculate at least an approximation of a volume (at least represented in a cube format) of physical space of physical object(s) associated with an inventory component(s) 126 (and any associated containers) and to compare said volume to the available volume of space available to a user through storage platform(s) 112 and/or a user's physical space (such as a garage or room). Further, space component 132 may be configured to calculate and display a 2D and/or 3D visual representation of inventory component(s) 126 for a user to see how the physical object(s) associated with each inventory component 126 is arranged within the one or more physical spaces. Such information may be provided by a user and/or by physical storage platform(s) 112 associated with a user. Further, space component 132 can be configured to compare available free physical space/volume for a user from a physical storage platform(s) 112 (such as space left in a rented storage container room) and compare the free space/volume to required space/volume information of a physical object when a new inventory component 126 for the physical object is created by a user and/or physical storage platform 112 and at least generating outgoing component 130 requests, for example, to facilitate a request to acquire additional physical storage space from a physical storage platform 112 to accommodate additional physical object(s) the inventory component(s) 126 represents/is associated with. It is contemplated space component 132 may also be located on physical storage platform 112 and associated with a user account if desired.

Notification component 136 may be configured to may be configured to generate and send notifications to a user. For example, notification component 136 may generate notifications relating to actions a user desires to be completed relating to an inventory component 126, such as the completion of the preparation and shipping of a physical object associated with an inventory component 126 by a physical storage platform 112 for said object stored at a particular physical storage platform 112 (or a problem therewith). In some implementations, notifications may be shown to users through user interfaces 110.

User Input Component 138 may be configured to receive one or more inputs from a user, generally through a client computing platform 108. User Input Component 138 may be configured to assist communication (sending information or receiving information) between a user and system 100 via user interface 110 or between a user and client computing platform(s) 108 (ideally via a user interface 110 on said platform). An example of a possible implementation of a user interface 110 would be a touchscreen, keyboard, mouse, video recording mechanisms, microphone, ECG, facial/gesture recognition technology, body movement technology, switches, buttons, and other known user interface devices which convey input to a computer or electronic device. In some embodiments client computing platform 108, user interface(s) 110, physical storage platform(s) 112, shipping platform 114, online sales/social media platform 116, disposal resources 118, and/or outside resources 120 may be included as part of server(s) 102 and thus may all exist on a single device (client device).

As depicted in FIG. 1, server(s) 102, client computing platform(s) 108, and outside resources 120 may be interconnected through various digital communication links, which may be established using networks like the internet or alternative network structures. It's important to emphasize that this description is not restrictive, as various embodiments covered by this disclosure could use different methods of connectivity.

Each client computing platform 108 (also referred to as client device) may incorporate several processors capable of running software modules that enable a user associated with client computing platform 108 to interact with system 100 and outside resources 120, along with performing other roles described in this specification to the client computing platform(s) 108. Examples of such platforms 108 include, but are not limited to, desktops, laptops, handhelds, tablets, smartphones, and/or other computer platforms.

Outside resources 120 can comprise of information sources or active entities outside to system 100, engaging with or participating within system 100. In certain cases, the roles typically associated with outside resources 120 might instead be managed internally within system 100.

Servers 102 are equipped with electronic storage 106 and one or more processors 104, among other elements as desired. These servers are designed with communication interfaces to facilitate the exchange of information across networks and with various computing platforms. The portrayal of server(s) 102 in FIG. 1 serves as an example and is not intended to be restrictive; server(s) 102 could be realized through a networked cloud of computing platforms that collectively deliver the functionalities described for Server(s) 102.

Electronic storage 106 includes media that retain information in a non-transitory manner. This storage might be part of the server(s) 102 hardware or connected externally through ports or drives. It might include various forms such as optical, magnetic, solid-state, and charge-based media, including cloud-based and other virtual storage solutions. This electronic storage is crucial for storing software, processed and incoming data from server(s) 102 and client computing platforms 108, and other data critical to the operational efficacy of server(s) 102.

Processor(s) 104 are tailored to manage data processing tasks within server(s) 102. They could include diverse processing entities like digital or analog processors, specialized circuits, quantum, or state machines. While represented as a single unit in FIG. 1 for simplicity, processor(s) 104 could encompass multiple processing elements either contained within a single physical unit or distributed across multiple units. These processors are responsible for executing various specified components through different means such as software, hardware, or firmware, which may enhance the processing capacity of server(s) 102.

Furthermore, it is important to understand that although the components such as accounting component 124, inventory component 126, incoming component 128, outgoing component 130, space component 132, notification component 136, and user input component 138, are depicted within a single unit in FIG. 1, in systems where processor(s) 104 comprises multiple units, these components could be configured separately or in combination at different locations. The functionality of these components as described is for illustration; they are adaptable, with possibilities for integration, modification, or omission, with their functions redistributed among other components as needed. This modular approach allows processor(s) 104 to potentially accommodate additional components that may undertake some or all of the tasks currently attributed to the existing components.

Turning to FIG. 2, a flowchart of a traditional process of building an inventory map 250 is shown. The inventory map 250 is a record of geographic positioning of a physical object(s) associated with an inventory component 126 in its relation to an address, building, room, or shelf and in relation to separate physical object(s)/containers (and ultimately their associated inventory component(s) 126), much like Matryoshka dolls or stacking dolls. An inventory map 250 is comprised of one or more attributes 146 of a location subcomponent 144 of an inventory component 126 for a physical object or item 262 which represents a location of the physical object 262 such as longitude and latitude or physical mailing address 252 (a first container) on the planet, and within that address 252 a building 254 (a second container) with a room or space 256 (a third container) where the physical object is located, and within that room or space 256 a shelf or collection space 258 (a fourth container) where if applicable, one or more boxes 260 may be located where the physical object or item 262 may located. Item 262 may be located in any container (such as first, second, third, fourth, etc.), such as located solely at an address 252 as an attribute 146 of location subcomponent 144 (or space component 132) for the inventory component 126 associated with item 262. Essentially the inventory map 250 is a collection of containers within containers evidencing the physical location of an object 262. Traditionally an inventory map of a physical object 262 is created from the bottom up (as indicated by the arrow in FIG. 2), by first creating an address 252, then a building 254 at the address, then a room 256 in the building 252, then a shelf 258 in the room 256, then a box 260 on the shelf 258, and finally the physical object or item 262 itself and connecting each attribute. This bottom up approach, although logical, requires a lot of planning ahead of time and a preorganization plan as well as knowledge about the specific characteristics of each object before the inventory map 250 can be created for tracking/tracing of physical object or item 262.

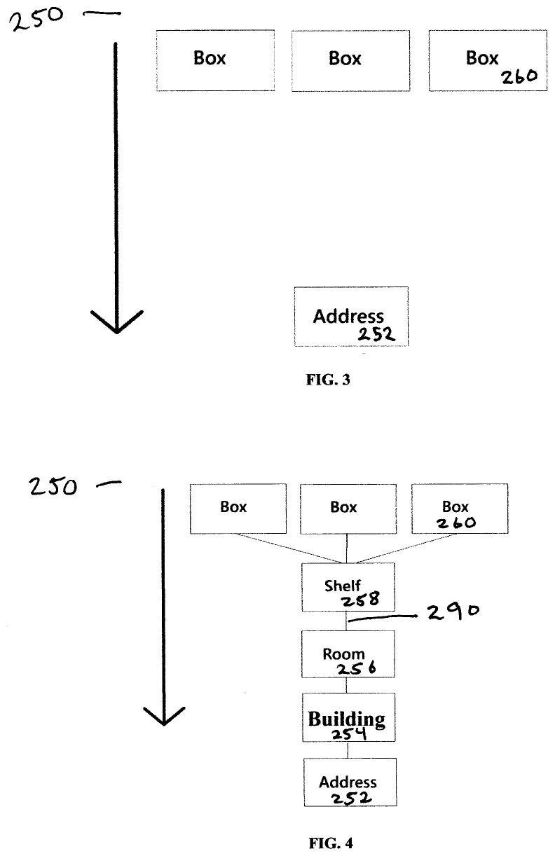

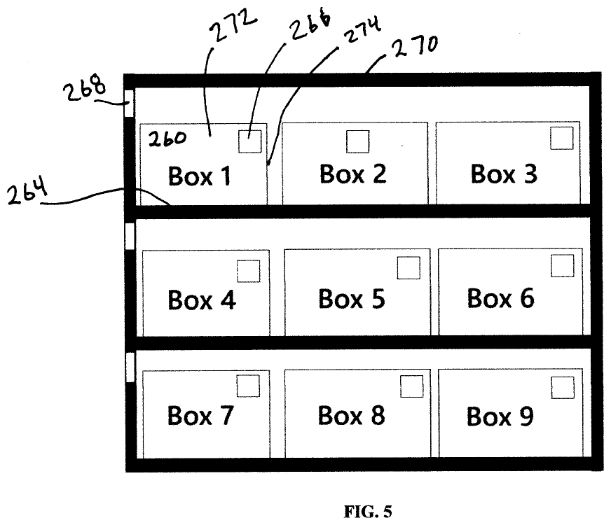

Turning to FIGS. 3, 4, and 5, a new approach to creating an inventory map 250 linking physical objects within a geographic location (address) 252 starts instead with the physical object 260 itself. As such, inventory components 126 for a physical object or item 260 without preplanning of organization/location/orientation is shown. Rather than preplanning the nesting container structure as well as to preselect a location of each container/box/object in three-dimensional space, the advantage of organizing physical objects in the moment (perhaps when packing them into containers), without preplanning can be facilitated by first creating an inventory component 126 (for example by using a user interface 110 on a client computing platform 108 or physical storage platform 112) for an item/object 262 and a location subcomponent attribute 146 containing at least the address 252 where physical item 262 is located. If desired, additional item subcomponent 142 attributes 146 could be created regarding the location of object 262. Next, an identification marker 266 (see FIG. 5) such as a QR or other identification code (or geotagging) may be generated by server(s) 102 and also assigned attributes 146 (of component(s) 126 printed using other resources 120 (using user interface 110) or another manner and affixed to object 262 or box 260 which object 262 is located within (wherein an attribute 146 linking a box 260 to an object 262 is facilitated by a user through user interface 110). Identification marker 266 may be another attribute 146 of location subcomponent 144 and identification marker 266 may simply be the object 262 or box 260 itself. Turning to FIG. 5, a potential organization of multiple boxes 260 on a rack 270 is shown. Rack 270 comprises at least one shelf 264 configured to support at least one box 260 (containing at least one physical object 262) or at least one physical object 262, an example of such rack 270 could be pallet racking.

Each box 260 contains an identification marker 266 affixed to, or printed upon, its outside surface (or as mentioned earlier, the box 260 itself may be the identification marker 266). Further, each shelf 264 may also have an identification marker 268 (such as a QR code or other geotagging modality or the shelf itself may be the identification marker) generated by server(s) 102 and may include a printout of attributes 146 of the associated inventory component(s) 126 and affixed near each shelf 264. Turning briefly back to FIG. 3, the next step is server(s) 102 populates an inventory map 250 for inventory component(s) 126 contained in a photograph/image (taken by a camera such as from a camera on a computing platform 108) associated with component(s) 126 (by server parsing the image for QR codes previously generated) and updating attributes 146 of at least each inventory component 126 location subcomponent 144 to include component 126 container association between endpoints of the map; that is, between address 252 and box 260 (or if there is not a box 260, then physical item 262 itself) server(s) 102 creates automatic linkage/association 290 (and stored in location subcomponent 144 attributes 146 of the inventory component(s) 126) between inventory component(s) 126 and any associated building 254, room 256, and shelf 258 as well as a location of box 260 or item 262 in relation to other inventory component(s) 266 with a shared address 252, building 254, room, 256, shelf 258, and/or box 260. To facilitate this process, an image or photo is taken by a user (via client computing platform 108 such as a smartphone) when they create or update an inventory component 126 and provide this image to the server 102/etc. via the user interface 110. Server(s) 102 processes the image and updates the attributes 146 of at least location subcomponent 144 of each inventory component 126 associated with each physical box 260/physical object 262 into the rest of the inventory map linking box 260/physical object 262 to a shelf 264 and rack 270, which may either have been previously associated with a room 256, building 254, and address 252 by a user when they first created the inventory component 126, or at the time the image is processed by server(s) 102. It is contemplated said image from client computing platform 108 may also have additional sensor data such as directional (such as a compass) indicating the direction the image was taken, GPS, gyroscopic, accelerometer, and other sensor data sent as part of the image file or separately to server 102 for processing to create inventory map 250. It is also contemplated one or more client computer platform 108 devices may acquire additional data to send to server 102 to assist in map 250 creation, such as depth-sensing cameras (Ex. LiDAR), radar imaging, sonar, ultrasound, photogrammetry, simultaneous localization and mapping, beacons, etc. It is also contemplated a server(s) 102 may be programmed via training and modeling to detect, identify, and decipher the spatial orientation to expedite creating inventory maps (and ultimately updating location subcomponent 144 attributes 146 with the associated container information where inventory component(s) is located based merely on a photo of a container with or without QR codes/geotagging of the associated physical object(s) in a container. In some embodiments, the server determines each container's 6-DoF pose from a single image by decoding a planar identification marker 266 (e.g., a QR or AprilTag) affixed to a known planar face 272 of the container (box 260 in the FIG. 5 for example). Given known camera intrinsics, the system estimates a homography H from the marker 266 corners to recover the container planar face 272 pose relative to the camera, and establishes a container-fixed coordinate frame with origin at a defined corner of the marker 266 and axes aligned to the container edges (edges 274 of box 260 in the present example). Item locations are computed by projecting detected item markers 266 onto a recovered plane (for items affixed to the face) or by intersecting 3-D rays with container planes when multiple tagged faces are visible. When only one face is visible (planar face 272 in the current case), depth is estimated using known container dimensions and the recovered face pose to infer interior (X, Y, Z) by planar offset from the face 272 and vertical stacking rules; uncertainty bounds are stored as part of the location subcomponent 144 attributes 146. In multi-sensor embodiments, camera and range sensors (e.g., LiDAR/ToF/ultrasound) are extrinsically calibrated using a calibration target co-visible across sensors. The server(s) 102 registers sparse point clouds to container planes (RANSAC plane fitting) and fuses detections using an Extended Kalman Filter that maintains the container pose and bounding geometry as state variables. If beacons are available, beacon signals (BLE/UWB) provide room-frame anchors via trilateration; the container frame is then transformed into the room frame. Fused estimates refine item (X, Y, Z) and container (box 260 in the current example) occupancy; covariance is persisted with each location attribute 146. Further, server(s) 102 may render a 2-D plan using orthographic projection of container rectangles in the inventory map 250 with per-item glyphs positioned at (X, Y) based on attributes 146 of the location subcomponent 144. A 3-D view extrudes container volumes and places items at (X, Y, Z) within each mesh; the view is derived from the persisted container pose (when available) and interior dimensions of the corresponding box 260, shelf 264, or other container. The resulting view is transmitted to the client computing platform 108 for display via the user interface 110.

The model just mentioned may be trained on images of labeled containers with ground-truth marker boxes, container planes, and poses. Loss functions include classification loss for marker type, L1/L2 losses for 2-D keypoints, and reprojection error for pose. Inference outputs a tuple per detection: (marker ID, 2-D keypoints, container-face ID, pose, confidence). The post-processor binds each detection to an inventory component 126 and updates the inventory map 250 accordingly.

It is also contemplated that server(s) 102 may be able to create an inventory map in two dimensions (X and Y) and/or three dimensions (X, Y, and Z) depending on the angle and content captured by the photo taken by the user. In addition, it is also contemplated that depending on the user's desire, a shelf 264, rack 270, room 256, or potentially box 260 could be omitted from attributes 146 location subcomponent 144 if desired in order to accurately reflect the location of a physical object 262.

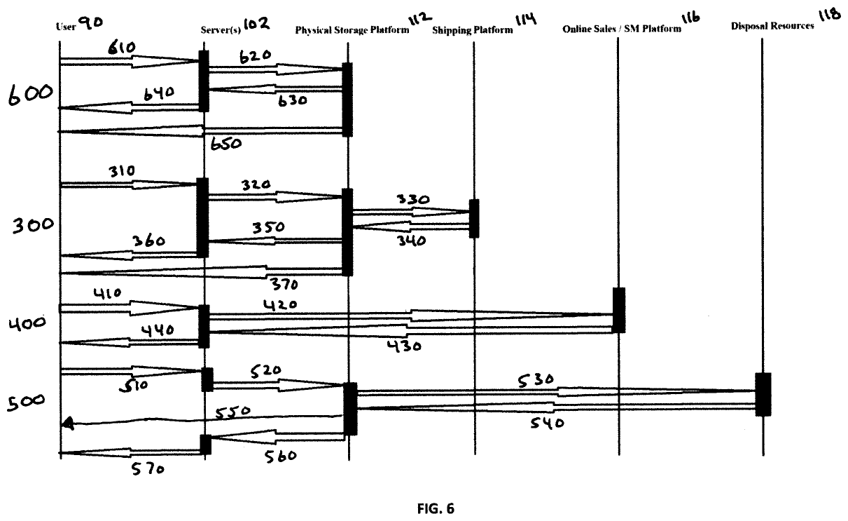

Turning to FIG. 6, a non-limiting example transactional diagram 20 illustrates a process of creating and inventory component(s) 126 in the system 100 to represent a physical object/item/inventory and the shipping, sale/display, and disposal of the physical object is shown. A first transaction 600 in transactional diagram 20 represents the creation of an inventory component 126 which begins with a user 90 logged into their user account via account component 124 initiates a create component request 610 which creates a new inventory component 126 instance or record stored in electronic storage 106 which includes at least one attribute 146 of item subcomponent 142. User 90 may also update one or more attributes 146 or add/remove attributes 146 from an item subcomponent 142, location subcomponent 144, and/or disposal subcomponent 134 of inventory component 126. After inventory component 126 is created by user 90, outgoing component 130 sends inventory component 126 information including at least location subcomponent 144 attributes 146 to physical storage platform 112 (identified as assign space 620). It is contemplated that user 90 via computing platform 118 likely may by separate and distinct from physical storage platform 112 or may actually be physical storage platform 112 if, for example, physical inventory is physically located at a physical storage platform 112 facility and personnel of the facility are building inventory component 126 instances for said physical inventory owned by a user. If user 90 is, for example, a customer of physical storage platform 112 and creates their own inventory components 126, user 90 may, through first transaction 600 send inventory component 126 information to physical storage platform 112 via assign space 620 to inform physical storage platform 112 of what physical inventory their facility will (or has) receive (d) from user 90. In return, physical storage platform 112 may, after confirmation the accuracy of at least location subcomponent 144 attributes 146, provide information to space component 132 associated with the correspondence inventory component 126 indicating a total amount of space (perhaps by, but not limited to, a volume calculation) user 90 has allocated (or rented) from physical storage platform 112 as well as how much is left for additional storage after the physical item associated with the inventory component 126 is subtracted from the previously available space, this is indicated as an update attribute 630 step on transactional diagram 20 to server 102 which then may sent a notice update 640 to user 90 indicating there is enough space to add the requested physical item. If user 90 does not have enough space to add a physical item associated with an inventory component 126 to (as calculated by physical storage platform 112 for user 90), physical storage platform 112 may communicate to server(s) 102 (via incoming component 128) to update space component 132 and send a notice to user 90 a space update 650 to user 90 that additional physical space needs to be rented or acquired by user 90. It is contemplated a user 90 may have physical inventory represented by inventory component(s) 126 at multiple addresses/multiple physical storage platforms 112.

A second transaction 300 in transactional diagram 20 represents the shipping of a physical inventory item represented by an inventory component 126 which begins with a user 90 logged into their user account via input component 138 initiates a ship component request 310 of an inventory component 126 which, via outgoing component 130, communicates a request (along with at least location subcomponent 144 attributes 146 indicating physical dimensions and weight of the physical inventory associated with inventory component 126) to physical storage platform 112 to prepare and ship the physical inventory associated with an inventory component 126 to an address provided by user 90 (or to make the physical inventory associated with an inventory component 126 available for pickup at a physical storage platform 112 facility by user 90 or a party authorized by user 90. Physical storage platform 112 prepares and ships said physical inventory by communicating at least dimensions, weight, and any shipping related information (such as if the physical inventory includes lithium-ion batteries or hazardous materials—which is located within at least location subcomponent 144 attributes 146 of inventory component 126 associated with the physical inventory being shipped) to shipping platform 114, such as UPS®, Fedex®, and/or the United States Postal Service via, ideally a function call to an Application Programming Interface (API) supported by shipping platform 114 (ship label request 330). Shipping platform 114 may provide cost and shipping labels to storage platform 114 (ship label 340), upon which physical storage platform 112 may update at least location subcomponent 114 attributes 146 in corresponding inventory component 126 and other attributes 146 to reflect the physical inventory associated with inventory component 126 with an account component 124 of user 90 to associate with an account component 124 of a different user the physical inventory was shipped to (if that user has an account with server(s) 102). Further, it is contemplated another system may contact user 90 to request transfer ownership/association of an inventory component 126 and its associated attributes and information with the other user. Last, notification that physical inventory associated with an inventory component 126 has left the physical storage platform 112 facility as well as status updates on the shipping process may be communicated to user 90 via notification component 136 associated with the inventory component 126 (notice update 360 via inventory component 126 or notice update 370 directly from physical storage platform 112).

A third transaction 400 in transactional diagram 20 represents the offering or listing of a physical inventory item represented by an inventory component 126 to the public for sale or for other reasons (such as for display) via an online sales/social media platform 116 which begins with a user 90 logged into their user account via user input component 138 initiates a request via outgoing component 130 via a function call to the desired online sales/social media platform 116 (such as Ebay.com, Amazon.com, Facebook.com, etc.) via a function call to an API supported by platform 116 which includes attributes 146 containing information to facilitate the user 90 desire (attribute send/listing 420), including potentially image and description information, pricing information, etc. contained within attributes 146 of item subcomponent 142. Once user 90 desired outcome has occurred, such as the sale of the physical inventory associated with inventory component 126, platform 116 sends a notice to inventory component 126 to update an attribute 146 that item has sold (update attributes 43) which sends a notice to user 90 via notification component 136 (notice item sold 440). It should be noted that second transaction 300 to ship said physical inventory does not occur automatically as user 90 generally needs to (but ultimately may not be required to) actively initiate second transaction 300 once, for example, payment is received and verified by user 90 before shipping said physical inventory.

A fourth transaction 500 in transactional diagram 20 represents the disposal of a physical inventory item represented by an inventory component 126, that is a relinquishment of legal title to the physical inventory item by having the storage platform 114 dispose item in the trash, recycle it, sell it on their own, or other disposal activities. Fourth transaction 500 begins with a user 90 logged into their user account via user input component 138 initiates a request to server(s) 102 via outgoing component 130 to physical storage platform 112 that an inventory component 126 is to be disposed of/user 90 is relinquishing legal tile to the physical inventory associated with inventory component 126 (assuming user 90 has the legal right to do so). With the request, the contents of disposal subcomponent 134 including attributes 146 thereof are also transmitted to physical storage platform 112 to provide specific disposal related information regarding the physical inventory associated with inventory component 126, which allows physical storage platform 112 to make a decision on said disposal based on financial, environmental, and business factors which may be important to physical storage platform 112.

It is contemplated server 102 could configured to directly communicate with shipping platform 114 and disposal resources 118 instead of first physical storage platform 112 if desired to complete first, second, third, fourth, and subsequent transactions. That is, in the preceding examples physical storage platform 112 interacted with shipping platform 114 and disposal resource 118 however server(s) 102 may directly interact with shipping platform 114 and disposal resource 118 independently of physical storage platform 112 and it is contemplated physical storage platform 112 may be located on server(s) 102 as can shipping platform 114, online sales/social media platform 116, and/or disposal resources 118.

While the present invention has been described above in terms of specific embodiments, it is to be understood that the invention is not limited to these disclosed embodiments. Many modifications and other embodiments of the invention will come to mind of those skilled in the art to which this invention pertain, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings. Likewise, where this document refers to technologies that would be apparent or known to one of ordinary skill in the art, such technologies encompass those apparent or known to the skilled artisan now or at any time in the future.

What is claimed is:

1. A computer-implemented method comprising:
receiving, from a client device, a photograph that depicts at least one physical object within a physical space;
parsing the photograph to decode one or more identification markers associated with at least one of: the physical object, a container that holds the physical object, or a location indicator within the physical space;
creating or updating, in electronic storage, an inventory record for the physical object that includes a location subrecord populated with hierarchical associations among one or more of: an address, a building, a room or space, a shelf or collection space, and a container;
when sensor data accompanies the photograph, determining and storing three-dimensional position attributes for the physical object within the container or the physical space; and
generating, for display to a user, a two-dimensional and/or three-dimensional visual representation of an arrangement of inventory records within available physical spaces based on the stored associations and the position attributes.

2. The method of claim 1, wherein the identification marker comprises a machine-readable code generated by a server and affixed to at least one of the physical object, the container, or the location indicator.

3. The method of claim 1, wherein parsing comprises automatically detecting codes previously generated for inventory records and updating an inventory map accordingly.

4. The method of claim 1, wherein the location subrecord further includes a nested-container indicator identifying whether the physical object is located within a first container and any higher-order container levels, together with position attributes within an innermost container.

5. The method of claim 1, wherein the sensor data comprises at least one of: directional data, satellite positioning, gyroscopic data, accelerometer data, depth-sensing camera data, radar imaging, sonar, ultrasound, photogrammetry, simultaneous localization and mapping, or beacon signals.

6. The method of claim 1, wherein one or more levels of the hierarchy are omitted when not applicable, while maintaining linkages among remaining levels.

7. The method of claim 1, further comprising sending, to a physical storage platform, a request to assign space based at least on the stored location subrecord and updating the inventory record to reflect allocation results.

8. The method of claim 1, wherein generating the visual representation includes comparing a volume associated with the inventory record to available volume provided by a storage provider and rendering the inventory record within an available region.

9. The method of claim 1, wherein the photograph is captured by a camera of the client device and provided via a user interface to a server for processing.

10. A computer system, comprising one or more processors and non-transitory memory storing instructions that, when executed by the one or more processors, cause the system to:
receive, from a client device, a photograph that depicts at least one physical object within a physical space;
parse the photograph to decode one or more identification markers associated with at least one of the physical object, a container that holds the physical object, or a location indicator within the physical space;
create or update, in electronic storage, an inventory record for the physical object that includes a location subrecord populated with hierarchical associations among one or more of: an address, a building, a room or space, a shelf or collection space, and a container;
when sensor data accompanies the photograph, determine and store three-dimensional position attributes for the physical object within the container or the physical space;
generate, for display to a user, a two-dimensional and/or three-dimensional visual representation of an arrangement of inventory records within available physical spaces based on the stored associations and the position attributes; and
send, to a physical storage platform, a request to assign space based at least on the location subrecord and update the inventory record to reflect allocation results.

11. A non-transitory computer-readable medium storing instructions that, when executed by one or more processors, cause a machine to:
receive, from a client device, a photograph that depicts at least one physical object within a physical space;
parse the photograph to decode one or more identification markers associated with at least one of the physical object, a container that holds the physical object, or a location indicator within the physical space;
create or update, in electronic storage, an inventory record for the physical object that includes a location subrecord populated with hierarchical associations among one or more of: an address, a building, a room or space, a shelf or collection space, and a container;
when sensor data accompanies the photograph, determine and store three-dimensional position attributes for the physical object within the container or the physical space;
generate, for display to a user, a two-dimensional and/or three-dimensional visual representation of an arrangement of inventory records within available physical spaces based on the stored associations and the position attributes; and
send, to a physical storage platform, a request to assign space based at least on the location subrecord and update the inventory record to reflect allocation results.

12. A computer-implemented method comprising: generating an identification marker for a physical object or a container; receiving a photograph from a client device; parsing the photograph to identify identification markers; and populating an inventory map by automatically linking the physical object or the container to at least one of an address, a building, a room or space, a shelf or collection space, and a container, and storing those linkages as attributes of a location subrecord of a corresponding inventory record.

13. The method of claim 12, further comprising displaying the two-dimensional and/or three-dimensional visual representation of the populated inventory map to a user via a client user interface.

14. The method of claim 12, further comprising ingesting sensor data accompanying the photograph and storing three-dimensional position attributes in the location subrecord.

15. The method of claim 1, wherein the visual representation depicts the physical space as a plan view or volumetric view and places graphical representations of physical objects or containers according to the stored associations and the position attributes.
